(19) United States
(12) Patent Application Publication
(10) Pub. No.: US 2005/0005588 A1
(43) Pub. Date: Jan. 13, 2005

(54) Lawnmower

(76) Inventor: Willem Jager, Breslau (CA)

Correspondence Address: RICHES, MCKENZIE & HERBERT, LLP, SUITE 1800, 2 BLOOR STREET EAST, TORONTO, ON, M4W 3J5, CA

(21) Appl. No.: 10/857,347

(22) Filed: Jun. 1, 2004

(30) Foreign Application Priority Data
May 29, 2003 (CA) 2,430,429

(51) Int. Cl. A01D 34/64

(52) U.S. Cl. 56/15.7

(57) ABSTRACT

A lawnmower comprising a generally horizontal metal deck having a top surface and a downwardly extending peripheral skirt, an electric motor mounted centrally of the deck rotating a vertical shaft carrying a horizontally disposed cutting blade below the deck within the skirt, wherein the motor comprises a heat dissipative brushless electric motor assembly comprising a hub which has a center through opening, an annular heat sink attached to said hub, said heat sink constructed of a heat conductive material, said heat sink being of a larger diameter than said hub, a controller for the motor, some of the heat that is generated by said controller to be conducted through said heat sink, a stator being fixedly mounted on said hub, said stator including wire coils which generate heat during operation of said motor assembly, and a rotor mounted about said stator, said rotor being secured to the shaft, said shaft being rotationally mounted within said center through opening, upon passing of an electrical current through said wire coils said rotor is rotated which rotates said shaft, wherein said heat sink is secured to the deck of the lawnmower to permit heat to be dissipated from the heat sink to the deck.

### SCOPE OF THE INVENTION

This invention relates to lawnmowers and, more particularly, to electric lawnmowers.

### BACKGROUND OF THE INVENTION

Many existing push lawnmowers have a relatively complex construction of metal and/or plastic components forming the deck, adjustable wheel mounts and handles. Many known lawnmowers suffer the disadvantage of including a wide variety of different components including, for example, plastic cowlings, housings and the like. These many components increase the cost of many known push lawnmowers.

### SUMMARY OF THE INVENTION

To at least partially overcome these disadvantages of previously known devices, the present invention provides a simplified construction arrangement for a push lawnmower and, more preferably, for an electric, preferably rechargeable, battery driven electric lawnmower.

An object of the present invention is to provide a simplified push lawnmower with a novel wheel mounting arrangement adaptable for mounting of all wheels.

Another object is to provide an electric lawnmower with a preferred brushless motor.

Another object is to provide an arrangement for a lawnmower adapted to easily receive a pair of rechargeable batteries between the rear wheels on each side of a central rearwardly extending handle.

According to one aspect, the present invention provides a lawnmower comprising:
a generally circular horizontal deck having a top surface and a downwardly extending peripheral skirt,
an electric motor mounted centrally of the deck rotating a vertical shaft carrying a horizontally disposed cutting blade below the deck within the skirt,
four wheels, each height adjustably mounted to the deck via a respective wheel mounting arrangement for varying the height of the deck relative each wheel,
each wheel mounting arrangement comprising a tubular member elongated about a longitudinal axis and having a first end and a second end,
a wheel axle extending horizontally through the tubular member normal the axis at the first end,
a respective wheel journalled on the wheel axis at the first end of the tubular member,
a pivot pin extending horizontally through the tubular member normal the axis at the second end of the tubular member,
a connector secured to the top surface of the deck and including a vertically disposed pivot flange and a vertically disposed height adjustment flange,
the pivot pin extending horizontally through the pivot flange and journaling the second end of the tubular member to the pivot flange for pivoting about the pivot pin,
the height adjustment flange including a plurality of spaced horizontally extending holes disposed in an arc centered on the pivot pin,
a horizontally disposed adjustment pin removably extending through one of the horizontal holes in the height adjustment flange and through a horizontal bore through the tubular member normal the axis to locate the wheel at predetermined height relative to the deck dependent upon one of the holes through the height adjustment flange in which the removable adjustment pin is located.

### BRIEF DESCRIPTION OF THE DRAWINGS

Further objects and advantages of the present invention will become apparent from the following description taken together with the accompanying drawings in which:

FIG. 1 is a perspective view of a first embodiment of a lawnmower in accordance with the present invention;

FIGS. 2, 3, 4, 5, 6 and 7 are, respectively, a left side view, top view, front view, right side view, rear view and bottom view of the lawnmower shown in FIG. 1;

FIG. 8 is an enlarged view of the lawnmower of FIG. 1;

FIG. 9 is a rear perspective view of the deck of the lawnmower of FIG. 1 with the wheels, wheel mounting arrangement, handle and batteries removed;

FIG. 10 is an exploded pictorial view of a rear support plate and a handle receiving channel member.

FIG. 11 is an external isometric view of a heat dissipative electric brushless motor assembly of United States Application 20030067228 to Vanjani, published Apr. 10, 2003 and suitable for use as the motor in the lawnmower of the present invention;

FIG. 12 is an exploded transverse cross-sectional view of the heat dissipative electric brushless motor assembly taken along line 12-12′ of FIG. 11; and

FIG. 13 is a transverse cross-sectional view through the casing in the exploded position as shown in FIG. 12 taken along line 13-13′ of FIG. 12, however, showing motor assembly as secured to the deck of a lawnmower as shown in FIGS. 1 to 10 in an inverted position.

### DETAILED DESCRIPTION OF THE DRAWINGS

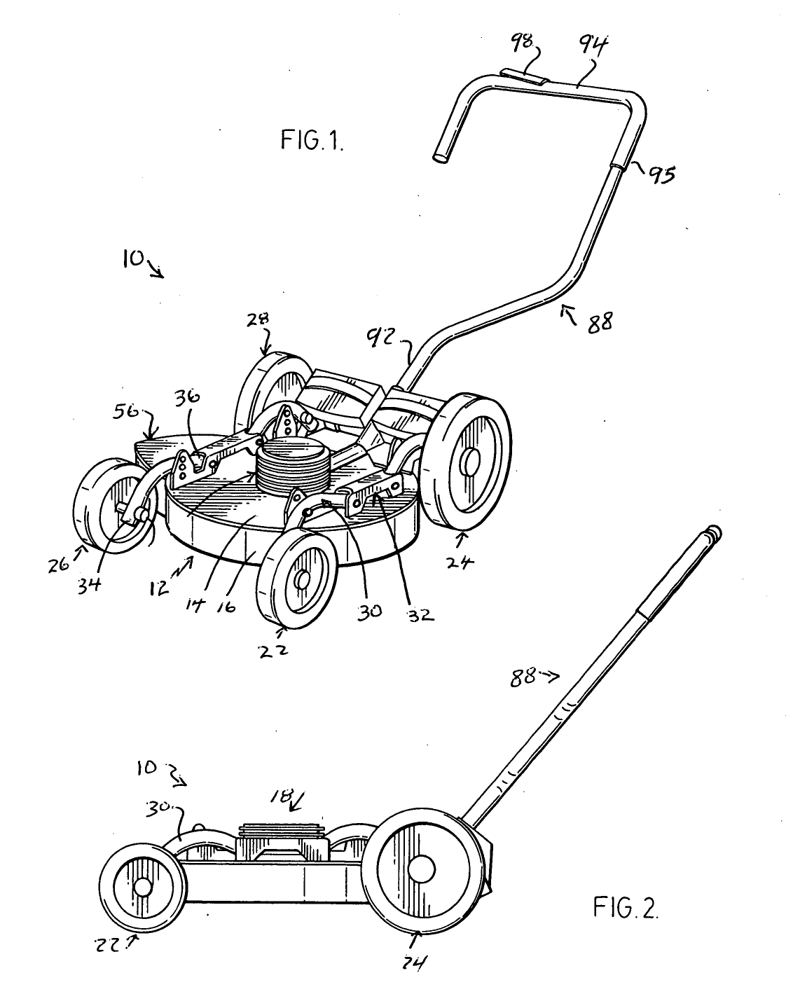

Reference is made to FIG. 1 which shows a lawnmower 10 in accordance with the first embodiment of this invention.

The lawnmower 10 includes a deck 12 formed from a thin, flat, circular top 14 having a downwardly extending cylindrical skirt 16.

An electric motor 18 is mounted to the top 14 of the deck concentrically thereon. In a known manner, a vertically disposed drive shaft 19 shown in FIG. 9 extends vertically downwardly from the motor 18 and carries a horizontal, rotatable grass cutting blade 20 seen in FIG. 9.

The motor 18 is preferably a brushless electric motor of the type disclosed in U.S. Pat. No. 6,104,113 to Vanjani, issued Aug. 15, 2000 and U.S. Pat. No. 6,321,863 to Vanjani, issued Nov. 27, 2001, the disclosures of which are incorporated herein by reference.

Four wheels 22, 24, 26 and 28 support the deck 12 above ground. Each wheel is mounted to the deck via a wheel mounting arrangement which is preferably as shown, substantially identical for each wheel. The mounting arrangement includes a tubular member 30 and a connector 32.

The tubular member 30 has a first end 34 and a second end 36. Each tubular member preferably comprises a hollow cylindrical tube. Each tubular member 30 is preferably straight as seen in top view, that is, lies within a vertical plain and is generally arcuate or C-shaped opening downwardly as seen in side view. The tubular member 30 has a central longitudinal axis.

A wheel axle 38 extends horizontally through the tubular member 30 normal the axis of the tubular member. One of the wheels is journalled on the wheel axle 38 with the wheel located outwardly to one side of the deck 12 from the tubular member 30.

The connector 32 is mounted to an upper surface of the top 14 and comprises a U-shaped channel portion 40 having a horizontal central bight 42 from which an inside leg 44 and an outside leg 46 extend vertically downward with the lower ends of the legs 44 and 46 secured to the top 14. The second end 36 of the tubular member 30 is received inside the channel portion 40 between the legs 44 and 46. A pivot pin 48 extends between the legs 44 and 46 and through the tubular member 30 normal its axis so as to secure the second end 36 of the tubular member 30 to the channel portion 40 for pivoting about the horizontal pivot pin 48.

The U-shaped channel portion 40 includes as an extension of its vertical inward leg 44 a height adjustment bracket 50 which extends from the channel portion 40 forwardly towards the first end 34 of the tubular member 30. The height adjustment bracket 50 extends vertically adjacent the tubular member 30 and carries a number of horizontally extending holes 52 therethrough disposed spaced from each other and arranged in an arc centered on the pivot pin 48.

An adjustment pin 54 is adapted to extend horizontally through one of the holes 52 in the height adjustment bracket 50 and through a horizontal bore through the tubular member 30 normal its axis to secure the tubular member 30 to the height adjustment bracket 50 against pivoting relative to the pivot pin 48 to locate the wheel carried on the tubular member 30 at a predetermined height relative to the deck 12.

In the preferred embodiment illustrated, each channel portion 40 is adapted to mount both a forward wheel and a rearward wheel with the tubular members 30 for each wheel extending forwardly and rearwardly from a central channel portion 40. Similarly, one height adjustment bracket 50 extends forward from the channel portion 40 and a second height adjustment bracket 50 extends rearwardly from the channel portion 40. As seen, given the larger diameter of the rear wheels 26 and 28, the height adjustment bracket 50 on the rear of the channel portion 40 extends upwardly a greater height and this permits, as is preferred, for each of the tubular members 30 to be identical in shape and size with the difference in radius the wheels being accommodated by the relative location of the holes in the height adjustment bracket 50 as may be accommodated by the increased height of the height adjustment bracket 50 for the increased radius rear wheels.

It is to be appreciated that the adjustment pins 54 are removable and that by simple removal and replacement of the height adjustment pins, the height of the deck may be adjusted. The height adjustment holes 52 are set at predetermined heights on each of the height adjustment brackets 50 such that with the adjustment pins 54 disposed in corresponding holes in each of the height adjustment brackets, the deck 12 may be disposed to be horizontal to the ground.

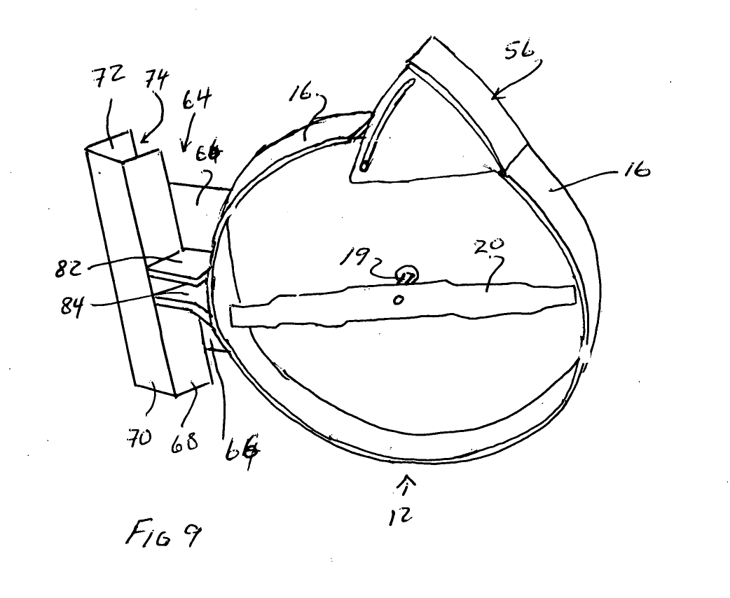

The deck 12 carries an adjustable discharge door 56 as best seen in FIG. 7. On one side of the deck 12, the skirt 16 is removed to provide an opening 62 and a door 56 which comprises a flat top plate 58 and an arcuate part skirt portion 60 is mounted to the deck 12 hinged to pivot relative to the deck 12 about a forward edge 61 between an open position permitting discharge of grass cuttings through the opening 62 in the skirt to a closed position in which the discharge door 56 substantially closes the skirt 16. The discharge door 56 may be clamped at any fixed position by reason of a clamping wing nut 63 on a bolt 99 received in a slot 65 in top plate 58.

As best seen in the perspective rear view of FIG. 9, a support plate 64 is secured to the top 14 proximate its rear and extends horizontally rearwardly as a first generally horizontal portion 66 then downwardly as a second portion 68, then rearwardly as a third portion 70, then upwardly as a fourth portion 72 so as to define with the second portion 68, the third portion 70 and the fourth portion 72 a generally upwardly directed U-shaped battery channel 74 adapted to receive two batteries 76 therein.

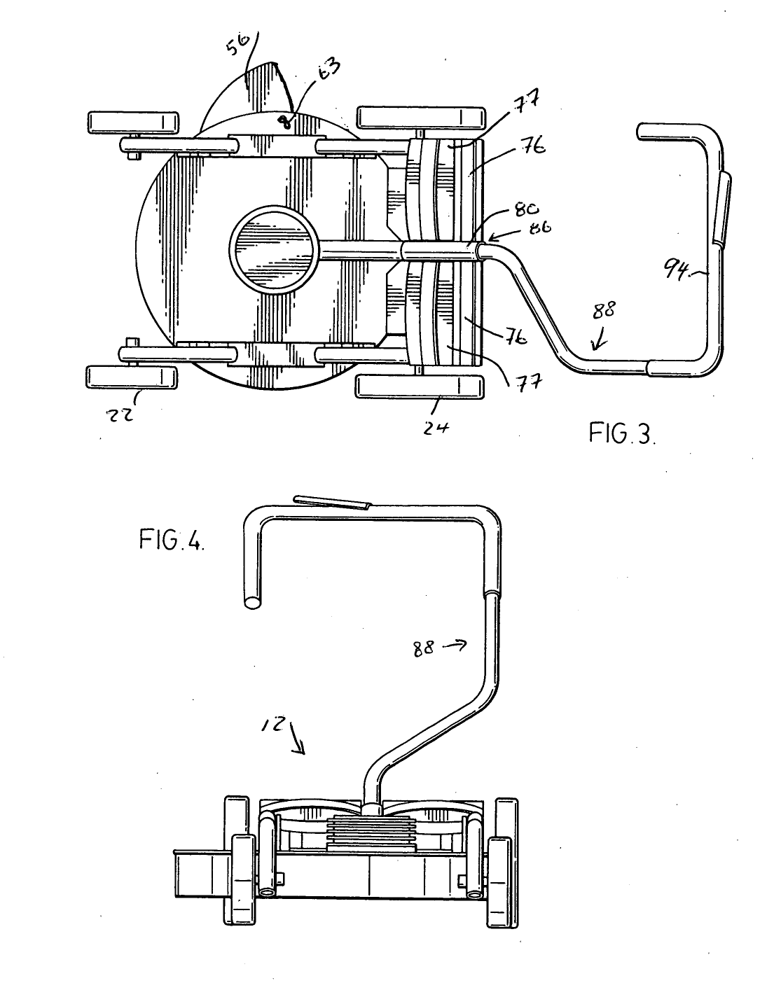

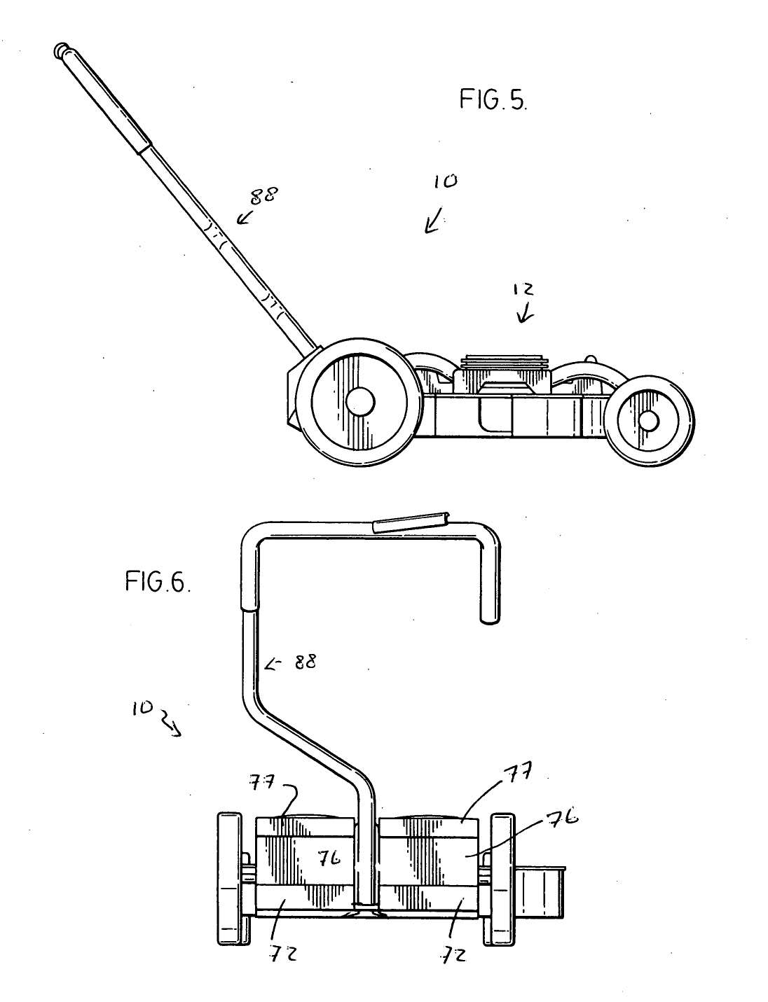

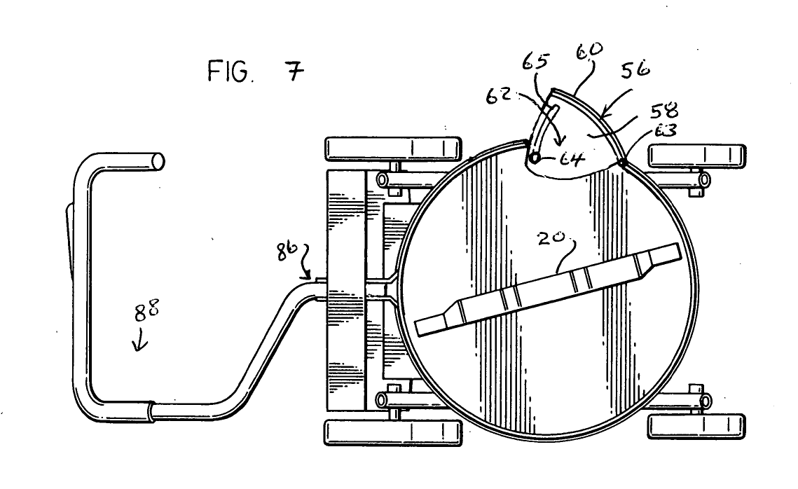

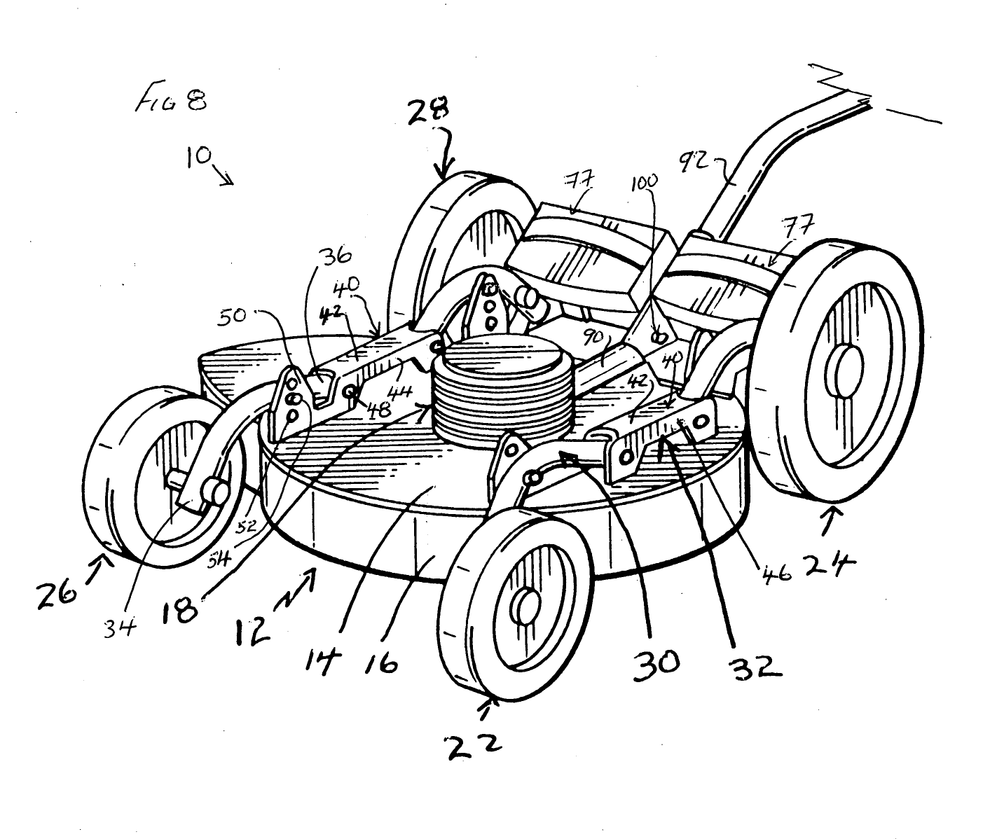

As best seen in FIG. 10, the first portion 66 and second portion 68 of the support plate have a central slot 67 cut rearwardly there into from the forward edge of first portion 66 and within this slot 67 there is received an upstanding U-shaped handle receiving channel member 78 which has an upper bight 80 and two downwardly extending legs 82 and 84. The fourth portion 72 also has a vertically extending central slot 73 cut therethrough. Forward edges of the legs 82 and 84 are secured to the skirt 16 at the rear of the skirt centered between the wheels. The legs 82 and 84 of the channel member 78 extend upwardly and rearwardly through the slot 67 in the first portion 66 and second portion 68 to engage and overlie the third portion 70 and end at and engage the fourth portion 72 on each side of slot 73 and extend upwardly therefrom to present, as marked on FIG. 3, a vertical slot 86 ending at the upper bight 80 marked on FIG. 3 into which slot 86 a forward portion 92 of a handle 88 may be inserted.

The handle receiving channel member 78 divides the battery channel 74 into two halves, one on either side of the handle 88. Two batteries 76 are adapted to be carried in the battery channel 74, one on either side of the handle 88. The batteries 76 are each covered by removable cover 77 which are electrically wired by wires which extend into the channel member 78 to permit removal of each battery and suitable electrical connection of each battery to the motor.

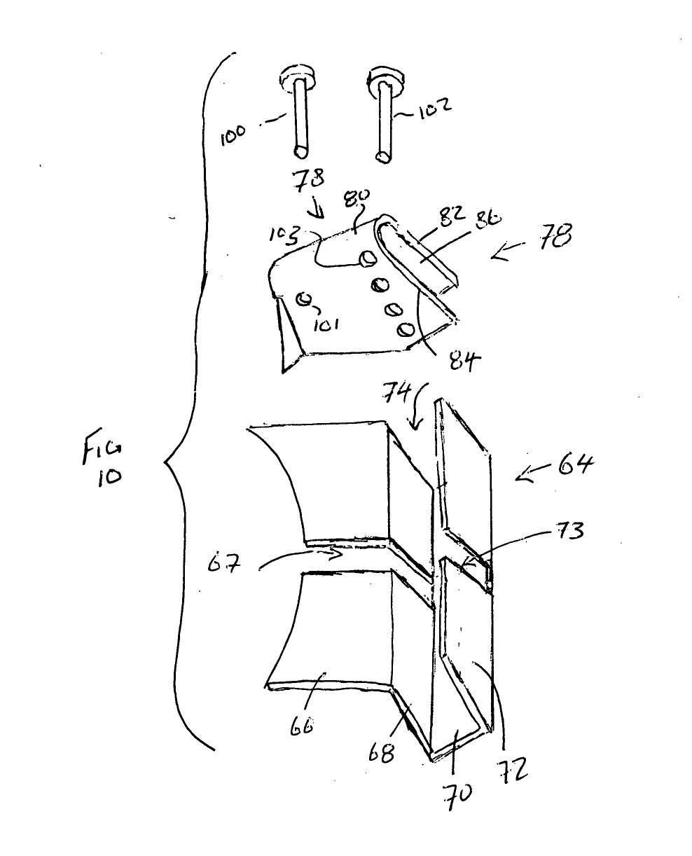

As seen in FIG. 8, the bight 80 of the handle receiving channel 78 extends at an angle forwardly with the bight 80 at a height above the top 14. A semi-circular, generally U-shaped conduit half channel 90 extends from a forward end of the handle receiving channel 78 to the motor and defines with the top 14, a conduit for passage of electrical wire from the motor to the handle receiving channel 78.

The handle 88 comprises a hollow tubular member bent in the shape generally of a question mark and having a straight forward portion 92 which is centered between the ends of a perpendicularly extending handle portion 94. The handle portion 94 is preferably covered by a rubber cover 95 providing comfort and ease of grip by a user. The handle carries a dead man's lever switch 98 pivotally mounted thereto and biased to an off position as shown in the Figures. On a user gripping the handle portion 94, the switch 98 is compressed to an on position.

The lower forward portion 92 of the handle 88 is received in the handle receiving channel member 78 and mounted therein by removable handle securing pins. Two securing pins are shown, a removable lower pin 100 which passes horizontally through forward lower holes 101 in the legs of channel member 78 and the handle proximate a forward end of the handle 88 and a removable upper pin 102 to be located in one of the holes 103 proximate the rear end of the handle receiving channel member 78 disposed in an arc from holes 101 and through the handle. The removable upper pin 102 is adapted to be located in one of a plurality of openings 103 through the legs of the handle receiving channel member 78 to permit the angle of the handle 88 to be adjusted relative to the deck thus adjusting the relative height of the handle 88 to a user. The handle 88 is pinned to the deck in a manner which resists relative rotation of the handle relative to the deck yet in a manner which permits the handle 88 to be removed from the deck.

Electrical connection of the switch 98 on the handle 88 to the motor is accomplished by electrical wiring passing internally through the handle 88 to the handle receiving channel member 78 and, hence, in the conduit formed under the half channel 90 to the motor.

Each of the tubular members 30 to support the wheels are preferably cylindrical metal tubes, however, could comprise a square tube. The top 14 and skirt 14 preferably are formed from sheet metal, preferably aluminum, and may form a rigid deck by being welded together about the periphery of the top 14. Similarly, each of the plate and handle channel member may comprise sheet metal formed to the desired shape and then welded together. The construction of the rear plate 84 with the upstanding handle channel 78 provides a truss-like construction providing strength and rigidity at low weight and one which can be manufactured easily at low cost.

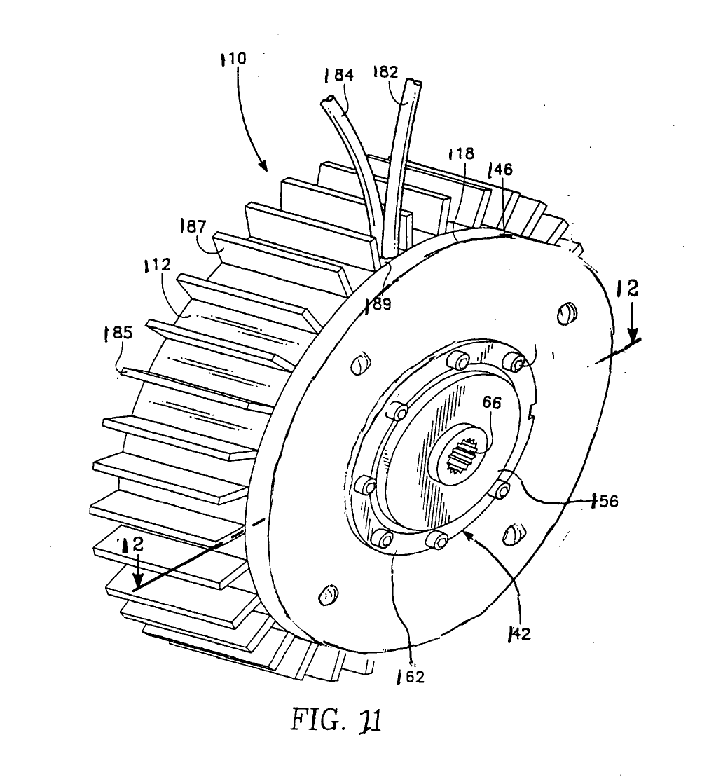

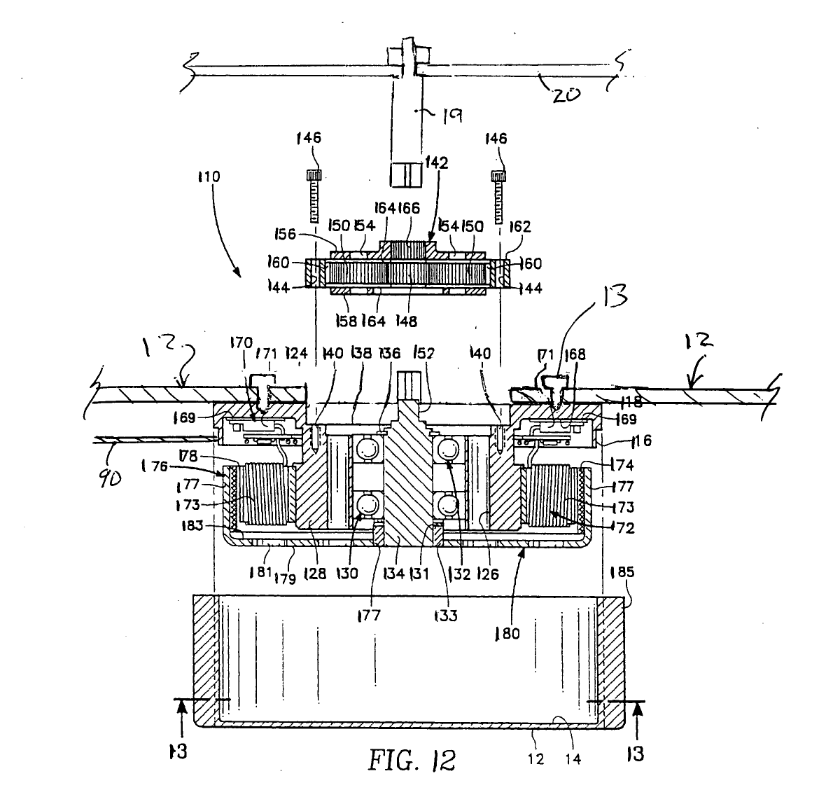

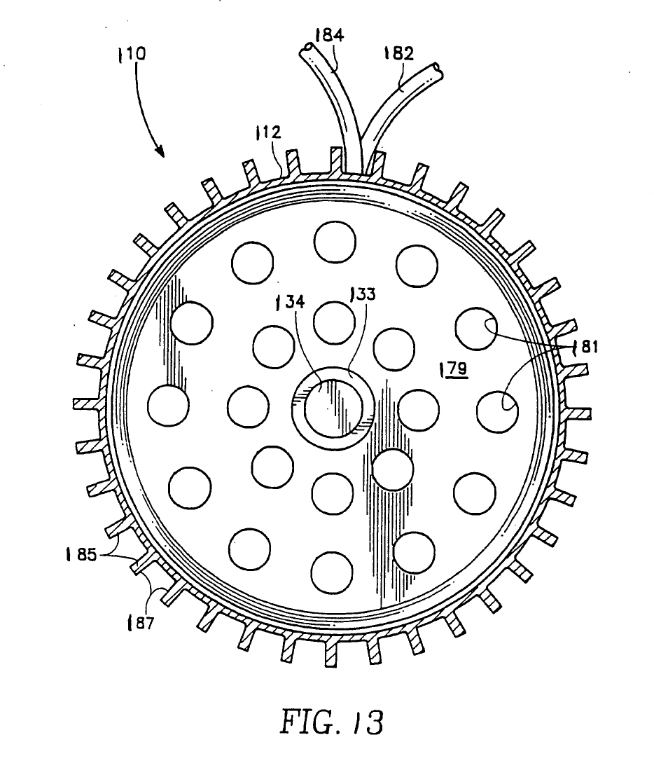

Referring particularly to FIGS. 11 to 13, there is shown an assembly 110 of the electric motor 18 of this invention which includes a cylindrically shaped casing 112 which has an internal compartment 114. The casing 112 is open at one end and is to be secured at annular groove 116 to a disc shaped heat sink 118. The heat sink 118 is constructed of a material such as aluminum that readily conducts heat. The heat sink 118 is to be secured directly to the top 14 of the deck 12 as seen in FIG. 12 to facilitate the conducting of heat from the heat sink 118 to the deck 12 and hence into the ambient. The heat sink 118 is to be secured directly to the top 14 of the deck 12 by bolts 199 received in holes 198 in the heat sink.

The heat sink 118 includes an alcove 124. The alcove 124 is basically cylindrically shaped and has a center through opening 126 connecting therewith. The center, through opening 126, is formed through a hub 128 which is integral with the heat sink 118. Heat sink 118 is constructed of a material that readily conducts heat, such as aluminum. Mounted within the center through opening 126 are bearings 130 and 132. Low, frictionally supported by the bearings 130 and 132 is a shaft 134. The shaft 134 is longitudinally fixed in position relative to bearing 32 by means of snap ring 136. The bearing 130 is preloaded by a disc leaf spring 131 which is held in place against bearing 130 by a bushing 133 which is mounted on shaft 134.

Mounted within the surface 138 of the hub 128 are a plurality of evenly spaced apart threaded holes 140. A planetary gear housing 142 is to be mounted within the alcove 124 in a close conforming manner. The planetary gear housing 142 includes a series of evenly spaced apart holes 144. Within each hole 144 there is to be located a threaded fastener 46, with each threaded fastener 146 to be threadably engaged with one of the threaded holes 140. This will securely mount the planetary gear housing 142 within the alcove 124. Within the planetary gear housing 142, there is mounted a sun gear 148 about which are mounted four in number of planet gears 150. The four planet gears 150 engage with the sun gear 148 within which there is located a spline connection, which is not shown. The spline connection of the sun gear 148 is to mechanically engage with the spline section 152 of the shaft 134.

Each of the planet gears 50 are rotatably mounted on separate stub shafts 154. The four in number of stub shafts 154 are fixedly mounted between an upper plate 156 and a lower plate 158. The planet gears 150 are in engagement with the ring gear 160 formed internally of a ring member 162. On each side of each planet gear 110, there is mounted a washer 164. The diameter of each washer 164 is slightly larger than the diameter of each planet gear 150. It is to be understood that the planet gears 150 are all of the same diameter. It is also to be noted that the sun gear 148 is of a substantially smaller diameter than the planet gears 150. The washers 164 function to keep the planet gears 150 longitudinally locked in position with the ring gear 160 by each washer 164 abutting against an edge of the ring gear 60. The upper plate 156 is locked to the lower plate 158 by means of the stub shafts 154.

The upper plate 156 includes a spline connection 166. The spline connection 166 is to connect to a driven shaft 19 on which the cutting blade 20 is carried. The driven shaft 19 is to be secured and journalled to the deck and/or motor in a known manner not shown as by thrust bearings

The heat sink 118 has an internal annular ledge 118. Mounted on the annular ledge 118 is a printed circuit board 119 on which are mounted the electronic components 111 of an electronic controller 110. The function of the electronic controller 110 is that it will control the variable speed at which the shaft 19 is operated. The controller 110 also will shut down the motor 18 when the motor 18 becomes overheated. The controller 170 will also shut off the motor 18 if the blade 20 of the lawnmower becomes locked.

It is to be understood that the electric motor 18 of the present invention could be utilized in a manner that it may not be necessary to include a planetary gear system.

Mounted on the exterior surface of the hub 128 is a stator 172. The stator 172 includes a series of wire coils 173. Coils 173 will generate some heat during operation. The stator 172 is fixed to the hub 128. Mounted about the stator 172 is a magnet ring 174, having multiple magnet poles, which is mounted on the inner, annular surface of a cup shaped cover 176. The cover 176 has an annular side wall 177 and a flat base 179. Flat base 179 has a series of venting holes 181 (twenty in number being shown which could be increased or decreased). Venting holes 79 could also be of a shape other than round. Venting holes 179 are to permit accumulated heat from controller 170 and coils 173 to be conducted from internal chamber 183 into internal compartment 114 where the heat is passed through aluminum casing 12 by conduction into the ambient. The discharge of the heat is also facilitated by the use of the fins 185 which provide a large surface area by which air can pass over fins 185 and dissipate the heat into the ambient. The air passes through slots 187 with there being a single slot 187 between each directly adjacent pair of fins 185. It is to be understood that the magnet ring 174 is slightly spaced from the stator 172 forming an annular gap 178. The cover 176 is centrally secured to the shaft 134. The cover 176 and the magnet ring 174 form the rotor 180 of the motor 18. The flat base 79 has a hole 177 within which is located the bushing 133.

The rotor 180 is to be positioned within the internal compartment 114 of the cover 112 and is to be permitted to freely rotate. Electrical operation of the stator 172 and the electronic components 171 of the controller 170 is accomplished by means of the electrical wires 182 and 184. Wires 182 and 184 pass through hole 185 in casing 112 and are to enter the conduit formed under half tube 90 and the top of the deck. The space surrounding wires 182 and 184 within hole 189 is sealed by epoxy resin (not shown). Electrical activation of the stator 172 will cause the rotor 180 to rotate which in turn will rotate the shaft 314. The spline section 152 will cause rotation of the sun gear 148 which will cause the planet gears 150 to rotate around the sun gear 148 and relative to ring gear 160 and will cause rotation of the upper plate 116 and lower plate 158. Therefore, the driven shaft 19 that is in engagement with the spline connection 166 will be rotated.

The electric motor 18 forms an overall disc shape which includes a controller 170 formed of electronic components 171 mounted there within and also is capable of including a planetary gear assembly mounted within the confines of the heat sink 118. Therefore, it is not necessary to utilize a separate controller and a separate planetary gear assembly, although a separate controller and a separate planetary gear assembly could be used.

While the invention has been described with reference to a preferred embodiment, many variations and modifications will now occur to persons skilled in the art. For a definition of the invention, reference is made to the appended claims.

1. A lawnmower comprising:
a generally circular horizontal deck having a top surface and a downwardly extending peripheral skirt,
an electric motor mounted centrally of the deck rotating a vertical shaft carrying a horizontally disposed cutting blade below the deck within the skirt,
four wheels, each height adjustably mounted to the deck via a respective wheel mounting arrangement for varying the height of the deck relative each wheel,
each wheel mounting arrangement comprising a tubular member elongated about a longitudinal axis and having a first end and a second end,
a wheel axle extending horizontally through the tubular member normal the axis at the first end,
a respective wheel journalled on the wheel axis at the first end of the tubular member,
a pivot pin extending horizontally through the tubular member normal the axis at the second end of the tubular member,
a connector secured to the top surface of the deck and including a vertically disposed pivot flange and a vertically disposed height adjustment flange,
the pivot pin extending horizontally through the pivot flange and journaling the second end of the tubular member to the pivot flange for pivoting about the pivot pin,
the height adjustment flange including a plurality of spaced horizontally extending holes disposed in an arc centered on the pivot pin,
a horizontally disposed adjustment pin removably extending through one of the horizontal holes in the height adjustment flange and through a horizontal bore through the tubular member normal the axis to locate the wheel at predetermined height relative to the deck dependent upon one of the holes through the height adjustment flange in which the removable adjustment pin is located.

2. A lawnmower as claimed in claim 1 wherein each tubular member for each wheel is identical.

3. A lawnmower as claimed in claim 1 wherein the pivot flange comprises one vertical leg of a U-shaped channel having a horizontal bight and two vertical legs extending downwardly therefrom to lowermost ends secured to the top surface of the deck,
the second end of the tubular member disposed within the channel between the two legs,
the pivot pin bridging between the two legs with the second end of the tubular member journalled on the pivot pin between the two legs.

4. A lawnmower as claimed in claim 3 wherein the height adjustment flange comprises a planar extension of one of the legs of the U-shaped member towards the first end of the tubular member.

5. A lawnmower as claimed in claim 4 wherein the pivot flange for a right front wheel and a pivot flange for a left rear wheel comprises the same said U-shaped channel and the pivot flange for a left front wheel and the pivot flange for a right front wheel comprise the same said U-shaped channel.

6. A lawnmower as claimed in claim 1 including a push handle comprising a tubular element having a first end and a second end, the tubular element formed into the shape of a question mark such that a forward end portion is disposed forwardly and centrally of a rear handle portion extending normal to the forward end portion and horizontally,
a handle receiving channel member secured to the top surface of the deck at the rear of the top surface and adapted to receive the forward end portion of the push handle against relative rotation.

7. A lawnmower as claimed in claim 6 including a U-shaped conduit forming member provided on the top surface of the deck forming a passageway between the conduit and the deck extending from the handle receiving channel member to the electric motor,
wherein a protective conduit for electrical wire is provided from the motor internally through the passageway to the handle receiving channel member into forward end of the handle member and internally within the handle member to the handle portion of the handle member,
a dead man's switch on the handle portion of the handle member biased to an off position and adapted to provide power to the motor only when engaged by a hand of a user.

8. A lawnmower as claimed in claim 1 including a handle extending from a rear of the deck centrally between the rear wheels,
two battery holder brackets are mounted to the deck rearward of the deck between the rear wheels with one battery holding bracket mounted on each side of the handle,
a rechargeable battery removably received on each battery bracket and adapted for electrical connection to the electrical motor.

9. A lawnmower as claimed in claim 1 wherein the electric motor comprises a brushless DC motor.

10. A lawnmower as claimed in claim 1 wherein the top surface of the deck comprises a circular, flat sheet of metal, the peripheral skirt comprises a vertically extending generally cylindrical sheet of metal welded at its periphery to an outer edge of the top deck,
each of the connectors comprises a metal U-shaped channel member welded to the top surface of the deck.

11. A lawnmower as claimed in claim 1 wherein each of the tubular members are identical.

12. A lawnmower as claimed in claim 11 wherein each of the tubular members are straight as seen in a vertical view and have a generally downwardly opening C-shape as seen in side view.

13. A lawnmower as claimed in claim 1 wherein the motor comprises a heat dissipative brushless electric motor assembly comprising:
a hub which has a center through opening;
an annular heat sink attached to said hub, said heat sink constructed of a heat conductive material, said heat sink being of a larger diameter than said hub;
a controller for the motor, some of the heat that is generated by said controller to be conducted through said heat sink;
a stator being fixedly mounted on said hub, said stator including wire coils which generate heat during operation of said motor assembly; and
a rotor mounted about said stator, said rotor being secured to the shaft, said shaft being rotationally mounted within said center through opening, upon passing of an electrical current through said wire coils said rotor is rotated which rotates said shaft,
wherein said heat sink is secured to the deck of the lawnmower to permit heat to be dissipated from the heat sink to the deck.

14. A lawnmower as claimed in claim 13 wherein said heat sink having an annular ledge, the controller including power devices of electronic components being mounted on said annular ledge.

15. A lawnmower comprising:
a generally horizontal metal deck having a top surface and a downwardly extending peripheral skirt,
an electric motor mounted centrally of the deck rotating a vertical shaft carrying a horizontally disposed cutting blade below the deck within the skirt, wherein the motor comprises a heat dissipative brushless electric motor assembly comprising:
a hub which has a center through opening;
an annular heat sink attached to said hub, said heat sink constructed of a heat conductive material, said heat sink being of a larger diameter than said hub;
a controller for the motor, some of the heat that is generated by said controller to be conducted through said heat sink;
a stator being fixedly mounted on said hub, said stator including wire coils which generate heat during operation of said motor assembly; and
a rotor mounted about said stator, said rotor being secured to the shaft, said shaft being rotationally mounted within said center through opening, upon passing of an electrical current through said wire coils said rotor is rotated which rotates said shaft,
wherein said heat sink is secured to the deck of the lawnmower to permit heat to be dissipated from the heat sink to the deck.

16. A lawnmower as claimed in claim 15 wherein said heat sink having an annular ledge, the controller including power devices of electronic components being mounted on said annular ledge.
